(19) United States
(12) Patent Application Publication
(10) Pub. No.: US 2002/0125625 A1
(43) Pub. Date: Sep. 12, 2002

(54) Free-standing door clamp

(76) Inventor: Kevin Klippel, Canyon Country, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/014,329

(22) Filed: Dec. 11, 2001

Related U.S. Application Data
(60) Provisional application No. 60/254,752, filed on Dec. 11, 2000.

(51) Int. Cl. B23Q 3/02

(52) U.S. Cl. 269/133

(57) ABSTRACT

A free-standing door supporting clamp includes a platform for engaging an edge of a door. First and second clamping members, each having a leg and an arm angularly offset from another, are pivotally attached to the platform. The first and second clamping members are each comprised of a rod having spring properties, such that upon placing the door onto the platform of the assembled clamp, the arms of the first and second clamping members pivot inward into flexing contact with the door, and the legs provide, with the platform, a stable support for the door over a floor or ground surface.

### RELATED APPLICATION

This application claims priority from United States Application Serial No. 60/254,752 filed Dec. 11, 2000.

### BACKGROUND OF THE INVENTION

The present invention relates to the preparation and installation of doors. More particularly, the present invention relates to a door clamp which holds the door in a free-standing position while the door is modified for installation or otherwise worked on.

In the construction of buildings, and particularly framed structures such as residential housing, significant effort is often directed to the preparation and installation of doors. Aside from the cutting and planing required to properly size the door so that it properly fits within the frame and accommodates for carpet, tile or other foreign materials, the door must also be mounted to the door frame with hinges. Also, various holes must be formed and aligned and the door and door frame for the installation of locks, deadbolts and the like. Previously installed doors must sometimes be modified when new handles and locks are installed.

The carpenter installing the door typically holds the door in a vertical position, while attaching the hinges and drilling the appropriate holes for handles and locks. Doors are often rather large, bulky and heavy and can be difficult to handle. Due to the elongated nature of the door, the carpenter must hold the top of the door with one hand while bracing his or her foot and lower leg against the bottom of the door while drilling, cutting, etc. Given this awkward arrangement, it is possible that the door can slip out of grasp of the carpenter while worked on. This can present an undue safety hazard for the carpenter, as the power tool can slip when the door moves. Also, the door may slip into and damage furniture, other finished carpentry or walls.

Accordingly, there is a need for a stabilizing means for supporting and securing the door in a vertical and free-standing position while these procedures are to be performed. The present invention fulfills this need and provides other related advantages.

### SUMMARY OF THE INVENTION

The present invention resides in a free-standing door supporting clamp that stabilizes and secures a door in a vertical and free-standing position so that various procedures and operations can be performed thereon, such as those described above.

The free-standing door supporting clamp generally comprises a platform for engaging an edge of a door. A first clamping member includes a leg and an arm that are angularly offset from one another, preferably by more than 90°. The first clamping member is pivotally attached to the platform. A second clamping member also having a leg and an arm which are angularly offset from one another, typically by more than 90°, is also pivotally attached to the platform, such that upon placing the door onto the platform, the arms of the first and second clamping members pivot inward into flexing contact with the door, and the legs, provide, with the platform, a stable support for the door over a floor or ground surface.

The first and second clamping members are comprised of a rod, typically of metal material, having spring properties. The legs of the first and second clamping members are generally quadrilateral in configuration, and the arms thereof are generally triangular in configuration, although the invention is not necessarily limited to such configurations.

The platform includes open-faced grooves formed in a lower surface thereof and spaced from one another for insertion of a portion of the first and second clamping members, typically intermediate the arm and leg. In order to engage and support doors of various widths, the platform may include three or more open-faced grooves.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view of a door clamp embodying the present invention;

FIG. 2 is an end view of the door clamp of FIG. 1;

FIG. 3 is an opposite end view of the door clamp of FIG. 2;

FIG. 4 is a side view of the door clamp of FIG. 1;

FIG. 5 is a top plan view of the door clamp of FIG. 1;

FIG. 6 is a bottom plan view of the door clamp of FIG. 1;

FIG. 7 is an exploded view of the door clamp of FIG. 1, illustrating the assembly of the components thereof;

FIG. 8 is a perspective view of the door clamp of the present invention in an open state and having a door, shown in phantom, being placed thereon;

FIG. 9 is a perspective view of the door clamp of the present invention having the door, shown in phantom, placed thereon so as to close the clamp about the door;

FIG. 10 is a diagrammatic view of the door clamp of the present invention in an open position and having a door placed thereon such that the door clamp pivots and flexes into the closed position, shown in phantom; and

FIG. 11 is an end view of a door supported by the door clamp of the present invention.

### DETAILED DESCRIPTION OF THE PREFERRED EMBODIMENT

As illustrated in the accompanying drawings for purposes of illustration, the present invention is concerned with a door clamp 10 for supporting unhinged doors in a vertical and free-standing position. The door clamp 10 is generally comprised of first and second clamping members 12 and 14 which support a platform 16.

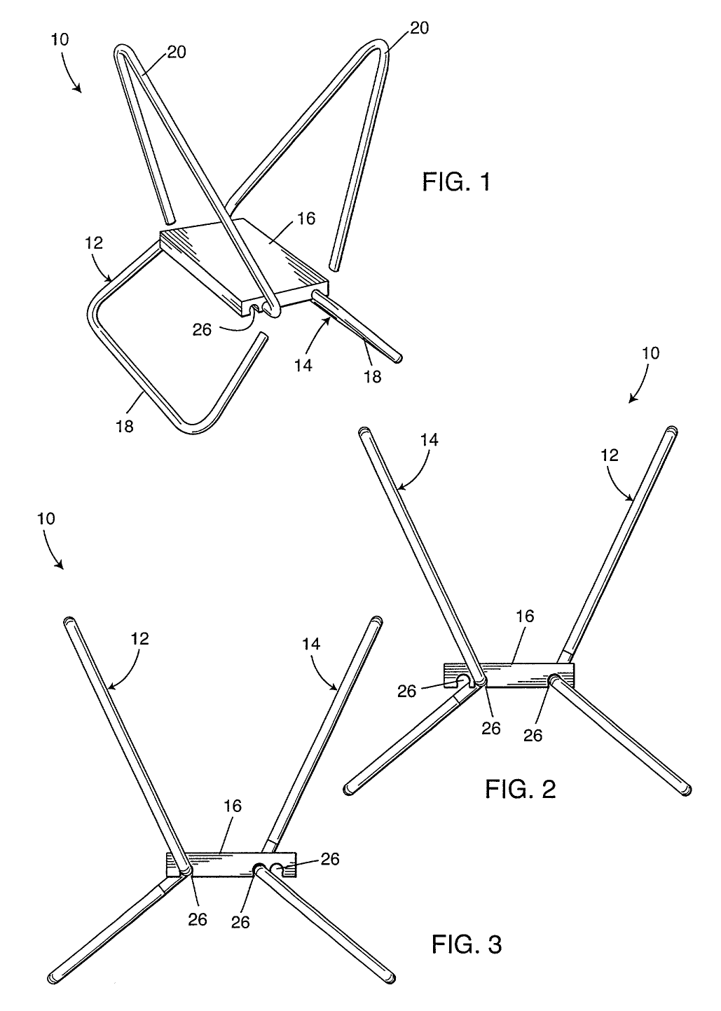

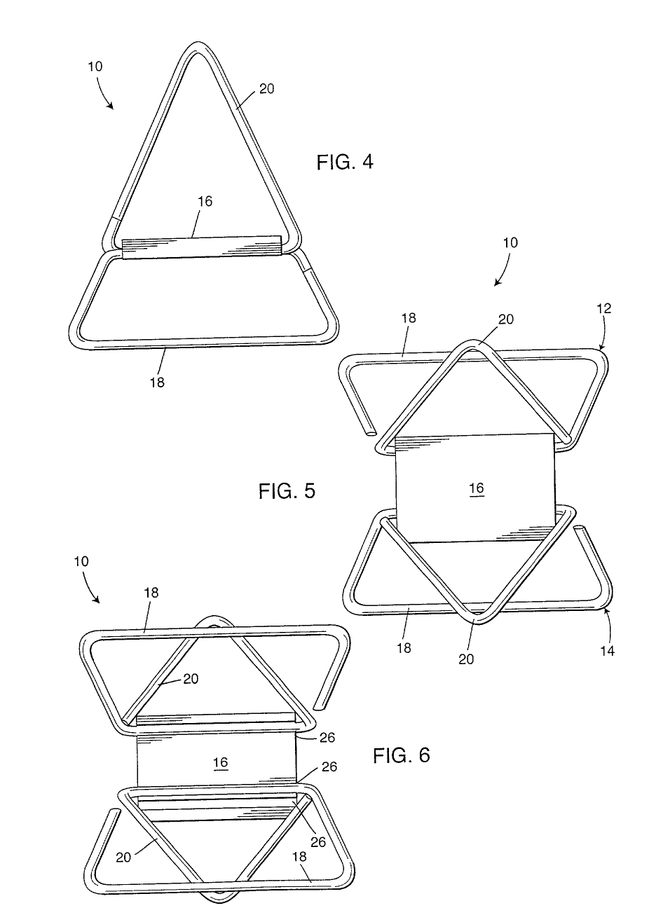

With reference to FIGS. 1-7, the first and second clamping members 12 and 14 are each comprised of a somewhat flexible and resilient rod which is bent into an irregular shape to form a leg 18 at one end thereof and an arm 20 at an opposite end thereof with an intermediate section 22 which serves as a pivotal anchor to the platform 16. As illustrated in FIGS. 2 and 3, the leg 18 and arm 20 do not lie in the same plane and form a V-like structure when viewed at an end thereof. Preferably, the leg 18 and arm 20 are angularly offset from one another by at least 90° in order to flex upon and pinch a door, as will be described more fully herein. As illustrated in FIG. 4, the leg 18 forms a trapezoid-like structure, and the arm 20 forms a triangle, although the invention is not limited to such a configuration. The rod is comprised of a material, such as metal or plastic having spring properties, which can be flexed from a relaxed state to a tensioned and sprung state and returned to the relaxed state when the force or pressure is removed.

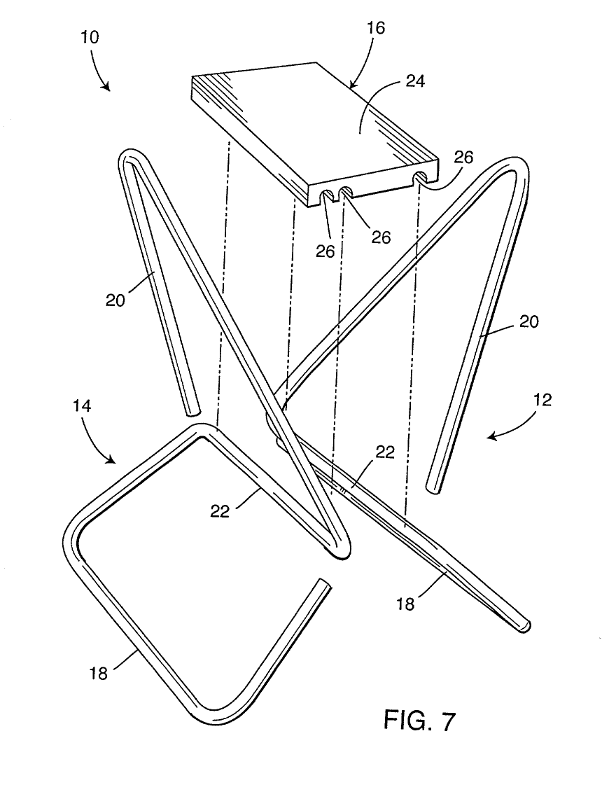

With particular reference to FIG. 7, the platform 16 is comprised of a relatively rigid and durable material, such as wood, plastic, metal or the like. A top surface 24 of the platform 16 is generally flat. Two open-faced channels 26 are formed in the bottom surface 28 of the platform 16 for receipt of the intermediate sections 22 of the first and second clamping members 12 and 14. The channels 26 extend across the entire length of the platform 16 and are spaced apart from one another by a predetermined distance. This distance is determined, in part, by the thickness of the door to which the door clamp 10 is to be applied. For example, if the door is relatively thick, the channels 26 are spaced further apart from one another, and if necessary, the platform 16 is enlarged. In contrast, if the door is relatively thin, the channels 26 are spaced much closer to one another. In order to accommodate doors of varying thicknesses, one or more channels 26 may be formed adjacent to one of the original channels 26 so that the user of the device may insert the intermediate sections 22 of the first and second clamping members 12 and 14 into the appropriate channels 26 to accommodate for the thickness of the door. The channels are configured such that the intermediate section 22 can be inserted into the channel 26 in a snap-fit manner, yet allow the intermediate section 22 to rotate or pivot therein.

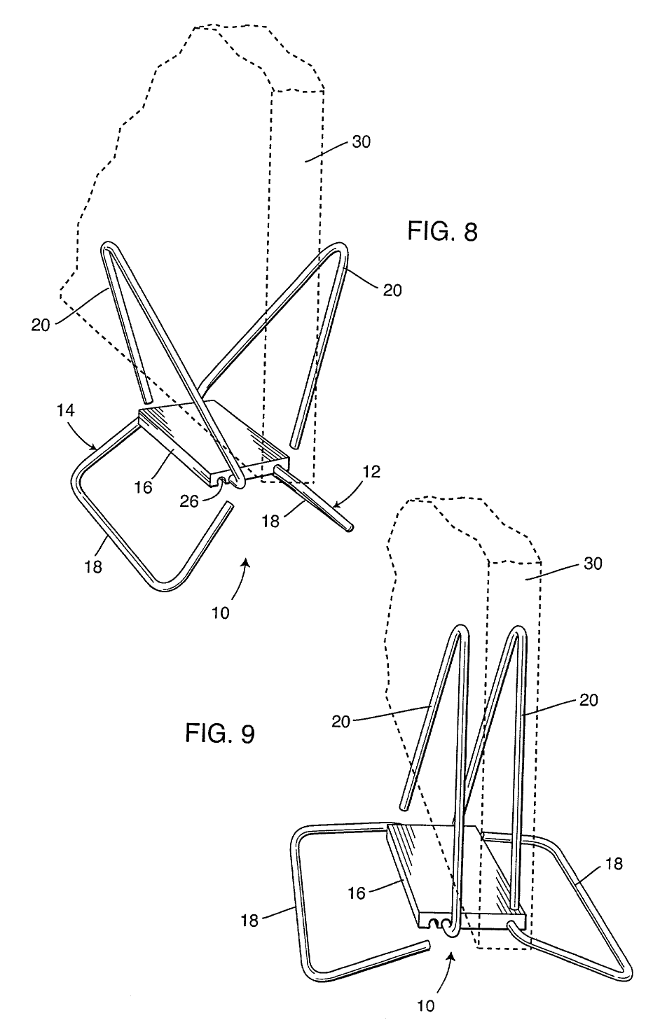

With reference to FIGS. 8-9, in use, the intermediate section 22 of the first clamping member 12 is inserted into a channel 26 of the platform 16, and the intermediate section 22 of the second clamping number 14 is inserted into the appropriate channel which will allow the door clamp 10 to fully close upon the door 30 as more fully described herein. In its relaxed state, the arms 20 of the first and second clamping numbers 12 and 14 extend away from one another to provide open access to the top surface 24 of the platform 16.

As illustrated in FIG. 8, in use, an edge, such as the bottom surface of the door 30 is inserted between the two arms 20 and onto the platform 16. As the weight of the door 30 rests upon the platform 16, the legs 18 of the first and second clamping numbers 12 and 14 flatten from an angled position to a near horizontal position, resulting in the two arms 20 rotating into a more vertical and upright position against the sides of the door 30. The legs 18 of the first and second clamping members 12 and 14, with the platform 16, cooperatively form a stable base and the arms 20 of the first and second clamping numbers 12 and 14 act to hold the door 30 in a vertical and free-standing position.

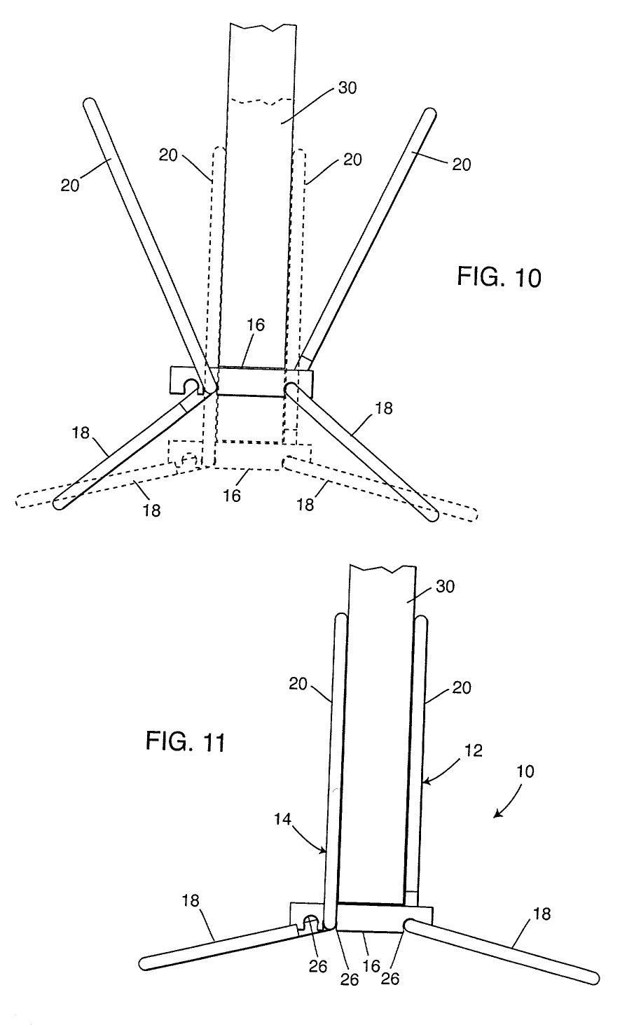

The movement of the door clamp 10 from an opened and relaxed position to a closed position resulting from the placement of the door thereon, is shown diagrammatically in FIG. 10. FIG. 11 shows the door 30 resting upon the platform 16 and the arms 20 of the first and second clamping numbers 12 and 14 pressed or flexed against the door 30 in a near vertical position.

The carpenter may leave the door on its hinges and merely require the use of one door clamp 10 on the end of the door 30 opposite the hinges in order to mobilize the door for drilling holes and the like for the installment of handles, locks, etc. There may be other instances, however, where a door clamp 10 is positioned on both ends of the door 30 to hold it in an upright position, such as when the door is removed from the hinges. With the door 30 secured in the closed door clamp 10, the carpenter is free to make any repairs or adjustments that are necessary without fear of the base of the door 30 slipping from its position within the door clamp 10. When the appropriate adjustments and installations are completed, the door 30 is lifted from the platform 16 and the release of the force upon the legs 18 will cause the clamping numbers 12 and 14 to return to their relaxed state, thus opening the door clamp 10 and permitting the removal of the door 30. In the event the door clamp 10 does not immediately return to its relaxed state, the carpenter can press down and pivot one of the legs 18 to move the arm 20 away from the door 30 and allow its removal.

It will be apparent to the reader that the door clamp 10 of the present invention provides many advantages to the carpenter. The door clamp 10 is relatively compact in size, and can be disassembled for storage and transportation. Also, doors of varying widths may be accommodated. The invention also provides a device which is very easy to assemble and use while providing a very stable support base for the free-standing door 30. The door clamp 10 will reduce the risk of injury to the carpenter, as well as the potential damage to surrounding objects with which the door might slip into without such a stable supporting base.

Although an embodiment of the present invention has been described in detail for purposes of illustration, various modifications of each may be made without departing from the spirit and scope of the invention. Accordingly, the invention is not to be limited, except as by the appended claims.

What is claimed is:

1. A free-standing door supporting clamp, comprising:
a platform for engaging an edge of a door;
a first clamping member having a leg and an arm angularly offset from one another, and being pivotally attached to the platform; and
a second clamping member having a leg and an arm angularly offset from one another, and being pivotally attached to the platform, such that upon placing the door onto the platform, the arms of the first and second clamping members pivot inward into flexing contact with the door, and the legs provide, with the platform, a stable support for the door over a floor or ground surface.

2. The door supporting clamp of claim 1, wherein the angle between the leg and arm of the first and second clamping members is greater than ninety degrees.

3. The door supporting clamp of claim 1, wherein the first and second clamping members are each comprised of a rod having spring properties.

4. The door supporting clamp of claim 3, wherein the rod is comprised of metal.

5. The door supporting clamp of claim 1, including elongated and open-faced grooves formed in a lower surface of the platform and spaced from one another for insertion of a portion of the first and second clamping members.

6. The door supporting clamp of claim 5, wherein the open-faced grooves are configured to receive a portion of the first or second clamping member intermediate the arm and leg thereof.

7. The door supporting clamp of claim 5, wherein the platform includes at least three elongated and open-faced grooves spaced from one another for engaging and supporting doors of various widths.

8. The door supporting clamp of claim 1, wherein the legs of the first and second clamping members are generally quadrilateral in configuration.

9. The door supporting clamp of claim 1, wherein the arms of the first and second clamping members are generally triangular in configuration.

10. A free-standing door supporting clamp, comprising:
a platform for engaging an edge of a door, and including elongated and open-faced grooves formed in a lower surface thereof;
a first clamping member having a leg and an arm angularly offset from one another by an angle greater than ninety degrees, and having a portion thereof inserted into an open-faced groove of the platform; and
a second clamping member having a leg and an arm angularly offset from one another by an angle greater than ninety degrees, and having a portion thereof inserted into an open-faced groove of the platform, such that upon placing the door onto the platform, the arms of the first and second clamping members pivot inward into flexing contact with the door, and the legs provide, with the platform, a stable support for the door over a floor or ground surface.

11. The door supporting clamp of claim 10, wherein the first and second clamping members are each comprised of a rod having spring properties.

12. The door supporting clamp of claim 11, wherein the rod is comprised of metal.

13. The door supporting clamp of claim 10, wherein the open-faced grooves are configured to receive a portion of the first or second clamping member intermediate the arm and leg thereof.

14. The door supporting clamp of claim 10, wherein the platform includes at least three elongated and open-faced grooves spaced from one another for engaging and supporting doors of various widths.

15. The door supporting clamp of claim 10, wherein the legs of the first and second clamping members are generally quadrilateral in configuration.

16. The door supporting clamp of claim 10, wherein the arms of the first and second clamping members are generally triangular in configuration.

17. A free-standing door supporting clamp, comprising:
a platform for engaging an edge of a door, and including at least three elongated and open-faced grooves spaced from one another for engaging and supporting doors of various widths;
a first clamping member comprised of a rod having spring properties and including a leg and an arm angularly offset from one another by an angle greater than ninety degrees, and having a portion thereof intermediate the arm and leg inserted into an open-faced groove of the platform; and
a second clamping member comprised of a rod having spring properties and including a leg and an arm angularly offset from one another by an angle greater than ninety degrees, and having a portion thereof intermediate the arm and leg inserted into an open-faced groove of the platform, such that upon placing the door onto the platform, the arms of the first and second clamping members pivot inward into flexing contact with the door, and the legs provide, with the platform, a stable support for the door over a floor or ground surface.

18. The door supporting clamp of claim 17, wherein the rod is comprised of metal.

19. The door supporting clamp of claim 17, wherein the legs of the first and second clamping members are generally quadrilateral in configuration.

20. The door supporting clamp of claim 17, wherein the arms of the first and second clamping members are generally triangular in configuration.
